(19) United States
(12) Patent Application Publication
(10) Pub. No.: US 2003/0158320 A1
(43) Pub. Date: Aug. 21, 2003

(54) Light weight ablative materials

(76) Inventors: David Kemmish, Lancashire (GB); Richard Thomas Leibfried, Chester Springs, PA (US)

Correspondence Address: BIRCH STEWART KOLASCH & BIRCH, PO BOX 747, FALLS CHURCH, VA, 22040-0747, US

(21) Appl. No.: 10/204,703

(22) PCT Filed: Feb. 26, 2001
(86) PCT No.: PCT/GB01/00779

(51) Int. Cl. C08K 3/34; C08K 3/40; C08K 3/04

(52) U.S. Cl. 524/449; 524/496; 524/494; 524/451

(57) ABSTRACT

The present invention is directed to the use of thermoplastic composite materials as ablative materials. It has been found that thermoplastic materials, reinforcing additives, a mineral, and optionally a foaming agent when combined produce an ablative material with good mechanical properties.

### BACKGROUND TO THE INVENTION

The present invention is directed to light weight ablative materials comprised of polyaryletherketones, fibres, minerals, and optionally foaming agents and/or some combination thereof.

The ablative art is principally concerned with materials for use as structural components for high temperature environments. A problem known to those skilled in the ablative art is the lack of light weight thermoplastic materials that can withstand the heat in an oxidizing environment and maintain structural integrity during high heat flux exposure. Light weight is desired to reduce the overall weight of the structure, thus decreasing the load.

The dynamic often associated with carbon based materials when subjected to heat and oxygen is the oxidation of the materials to carbon gases, resulting in the loss of material structure and function. The present invention combines materials based on light weight carbon compositions often eschewed as ablative materials because of the heat/oxidation dynamic. The compositions of this invention incorporate the dynamic and, surprisingly, are calculated to provide ablative materials that maintain structure and function.

Polyetheretherketone (e.g. PEEK™ available from Victrex Plc, U.K.) is know as a light weight material capable of retaining mechanical properties at high temperatures.

However, polyetheretherketone melts at 340 degrees centigrade and at higher temperatures decomposes to produce a black carbonaceous char which oxidizes and/or spalls off the structure in chunks. As a consequence, polyetheretherketone has not been considered for use in environments which generate heat greater than its melting point. The present invention contemplates heat resilient ingredients and structural reinforcers that extend the useful temperature of polyetheretherketone materials. This results in a light weight composite material useful for ablative purposes.

Ablative materials are generally useful for missiles, especially the fins of missiles. The materials of the present invention are found useful as ablative material, but may be used in environments which are as or less demanding as those confronted by ablative materials.

### SUMMARY OF THE INVENTION

The ablative material comprises a thermoplastic material such as polyaryletherketone, a reinforcing additive, a mineral, and optionally a foaming agent. Preferably, the polyarlyetherketone, further discussed in “Polyetheretherketone” by D. J Kemmish, in Rapra Review Vol. 2, No. 2, 1988 incorporated herein by reference for its full disclosure therein, is comprised of polyetheretherketone (e.g. PEEK™), polyetherketone (e.g. PEK™ of Victrex Plc, U.K.), polyetherketoneetherketoneketone, (PEKEKK), polyetherketoneketone (PEKK), polyetheretherketoneketone (PEEKK), copolymers thereof such as sulfone and/or biphenyl containing polymers, and combinations thereof and therebetween. Most preferably the polyaryletherketone is comprised of polyetheretherketone and/or polyetherketone. The thermoplastic is suitably present by weight percent from 25 to 9 percent, preferably from 40 to 80 percent, and most preferably from 48 to 70 percent.

The reinforcing additive is suitably comprised of platey, fiberous and/or whiskers of organic and/or inorganic materials. The organic materials are comprised of carbon fibres, aramid fibres, and like materials. The inorganic materials are comprised of glass such as quartz, silicates, borates, and/or aluminates, ceramics such as borides, nitrides, and/or ceramics or glass comprised of elements from the first, second and/or third transition series, metallic additives comprised of elements from the first, second, and/or third transition series and/or combinations thereof and therebetween. Preferably, the reinforcing additive is comprised of carbon and/or glass fibres, and most preferably carbon fibres. The reinforcing additive is suitably present by weight percent from 3 to 70 percent, preferably from 10 to 50 percent, most preferably from 20 to 40.

The mineral additive is suitably comprised of any material that can be processed at the thermoplastic processing temperatures up to about 430 degrees centigrade.

Preferably, said minerals comprise talc, vermiculite, mica, quartz, any of the endothermically decomposing minerals, and/or combinations thereof and therebetween and most preferably talc. The mineral additive is present by weight percent from 2 to 50 percent, preferably 2 to 30 percent, and most preferably 3 to 20 percent.

The optional foaming agent is suitably comprised of any material which produces volatile gases during the dynamic high heat exposure. Preferably, the agent is comprised of a halopolymer such as fluoropolymers, chloropolymers, and/or chlorofluoropolymers, and most preferably polytetrafluoroethylene (PTFE). The foaming agent may be present by weight percent from 0 to 49 percent, preferably from 0 to 30 percent, and most preferably 0 to 15 percent. Suitably, the foaming agent is present at a level of at least 1 weight percent, preferably at least 2 weight percent, more preferably at least 3 weight percent.

The invention extends to the use of a material described above as an ablative material.

The invention extends to the use of an ablative material as described above for dissipating heat from a substrate.

The invention extends to a method of dissipating heat from a substrate, the method using an ablative material as described above.

The invention extends to a method of preparing a structure for use in a high temperature environment, the method comprising associating with the structure an ablative material as described above.

The invention extends to a structural component for use in a high temperature environment, said component including an ablative material as described above.

A high temperature environment may be an environment wherein the temperature is at least 400° C., at least 600° C. or at least 800° C.

In its most general form, the thermoplastic ablative compositions are mixed in the following manner. As known to those skilled in this art, the compositions disclosed herein may be mixed in batch form or may be incrementally mixed as the composition is processed. The thermoplastic component in either pellet or powdered form is mixed with powdered mineral, reinforcing additive, mixed in a blender, and then melt processed. Sometimes, the mixing is performed during the melt processing dependent upon the type of extruder in use. The melt processed product is then allowed to cool to room temperature. Optionally, the foaming agent is admixed during the mixture of the thermoplastic, reinforcing, and mineral components.

Specific embodiments of the invention will now be described, by way of example.

### EXAMPLE 1

7.9 kilograms of 450PC Victrex PEEK™ (obtainable from Victrex Plc, U.K.), 4.1 kilograms of Fortafil carbon fibre (obtained from Akzo), 817 grams of PTFE TL-156 (obtained from ICI), and 817 grams of talc Mistron Super Frost (obtained from Cypress Industrial Minerals) were tumble blended in a Marion Blender producing a premix. The premix was fed to a 6.35 centimetre single screw extruder producing an extruded lace. The extruded lace was cooled to solidification and pelletized producing pellets of approximately 0.31 by 0.31 centimetre cylinders. 7 grams of a stearate salt was added. The pellets were dried for 3 hours at 150 degrees centigrade and then injection moulded producing 0.31×15.2×7.6 centimetre plaques.

The plaques were then positioned vertically lengthwise by clamps at the top of the cylinders and the bottom of the cylinder resting on a surface. The plaques were exposed to a flame from a propane torch at approximately 1200 degrees centigrade for ten minutes. During this test the surface of the plaques were observed to evolve volatiles forming a foam product adhering to the heat treated plaque surface. The foam product was determined to be a cross-linked carbonaceous polyetheretherketone degradation product. The surface of the foam was observed to glow at red heat during the test however, no foam burn through or plaque sag was observed or detected due to this testing procedure. The foamed surface was observed to have glazed at the places where the heat was most intense, indicating some hardened glassy and/or ceramic product had been formed. It is important to note that no burn through of the foamed product was observed. Burn through means for this analysis, that the foam product exposed to the direct flame was vaporized producing a flame channel within the foam product during this flame test.

### EXAMPLE 2

Example 2 was produced similarly to Example 1 except that the amount of talc was doubled to 1.6 kilograms and the PTFE was omitted. All other processing parameters remained the same. During the burn through test, foaming was observed to occur but to a lesser extend than that observed in Example 1. The foamed surface was observed to be highly resistant to burn through, some plaque sag occurred.

### EXAMPLE 3

Example 3 was produced similarly to Example 1 except that the amount of polyetheretherketone was 7.5 kilograms, the amount of carbon fibre was changed to 4.1 kilograms, and the amount of PTFE was 2.1 kilograms. No talc was added to this Example. During the flame test a high degree of foaming was observed. In addition rapid burn through was observed in this sample and plaque sag was observed.

### EXAMPLE 4

Example 4 was produced similarly to Example 1 except that the amount of polyetheretherketone was 9.5 kilograms and the amount of carbon fibre was changed to 4.1 kilograms. Neither talc nor PTFE was added to this batch. During the flame test some foaming occurred. In addition rapid burn through was observed in this sample and plaque sag was observed.

### EXAMPLE 5

Example was produced similarly to Example 1 except that polyetheretherketone was the only component in the example. No carbon fibre, PTFE, nor talc was added to this batch. During the flame test the surface started to foam but the material rapidly melted away from the flame.

The following mechanical properties shown in Table 1 were determined for Examples 1, 2 and 4.

TABLE 1

| Mechanical Property | Example 1 | Example 2 | Example 4 |
|---|---|---|---|
| Tensile Strength, psi | 32,000 | 30,000 | 33,000 |
| Tensile Elongation, % | 2.0 | 1.8 | 3.6 |
| Flexural Modulus 10⁶ | 3.2 | 3.0 | 2.9 |
| Notched Izod ft/lbs/in | 1.55 | 1.37 | 1.8 |

Notably the properties observed in Example 1, the composition of this invention, are comparable to those in Example 4, known for desirable mechanical properties for other than ablative purposes. The addition of either PTFE and talc or talc alone had no significant effect on the mechanical properties but added a new desirable ablative property and use in its resistance to a high heat flux.

1. An ablative material comprising a thermoplastic material, a reinforcing agent and a mineral.

2. An ablative material according to claim 1 wherein said thermoplastic material comprises a polyaryletherketone.

3. An ablative material according to claim 2 wherein said polyaryletherketone is selected from polyetheretherketone, polyetherketone, polyetherketoneetherketoneketone, polyetherketoneketone, polyetheretherketoneketone, copolymers thereof and/or combinations thereof and therebetween.

4. An ablative material according to claim 2 or claim 3, wherein said polyaryletherketone is polyetheretherketone and/or polyetherketone and/or some combination thereof and therebetween.

5. An ablative material according to any preceding claim, wherein said reinforcing agent comprises organic and/or inorganic materials.

6. An ablative material according to any preceding claim, wherein said reinforcing agent is comprised of carbon fibres.

7. An ablative material according to any preceding claim, wherein said reinforcing agent is comprised of glass.

8. An ablative material according to any preceding claim, wherein said mineral is comprised of endothermically decomposing materials.

9. An ablative material according to any preceding claim, wherein said mineral is comprised of talc.

10. An ablative material according to any preceding claim, wherein said mineral is comprised of talc, vermiculite, mica, quartz, and/or combinations thereof and therebetween.

11. An ablative material according to any preceding claim, comprising 25 to 95 weight percent thermoplastic material, 3 to 70 weight percent reinforcing agent and 2 to 50 weight percent of a mineral.

12. An ablative material according to any preceding claim, comprising 40 to 80 weight percent thermoplastic material, 10 to 50 weight percent reinforcing agent, and 2 to 30 weight percent mineral.

13. An ablative material according to any preceding claim, comprising 48 to 70 weight percent thermoplastic material, 20 to 40 weight percent reinforcing agent, and 3 to 20 weight percent mineral.

14. An ablative material according to any preceding claim, comprising a foaming agent.

15. An ablative material according to claim 14 comprising 0 to 49 weight percent foaming agent.

16. An ablative material according to claim 14 comprising 0 to 30 weight percent foaming agent.

17. An ablative material according to claim 14 comprising 0 to 15 weight percent foaming agent.

18. The ablative material according to any of claims 14 to 17, wherein said foaming agent comprises PTFE.

19. An ablative material according to any of claims 14 to 17, wherein said foaming agent comprises a halopolymer.

20. An ablative material according to any preceding claim, wherein said material is used for missile fins.

21. Use of a material according to any of claims 1 to 19 as an ablative material.

22. Use of an ablative material according to any of claims 1 to 19 for dissipating heat from a substrate.

23. A method of dissipating heat from a substrate, the method using an ablative material according to any of claims 1 to 19.

24. A method of preparing a structure for use in a high temperature environment, the method comprising associating with the structure an ablative material according to any of claims 1 to 19.

25. A structural component for use in a high temperature environment, said component including an ablative material according to any of claims 1 to 19.
